(19) United States
(12) Patent Application Publication
(10) Pub. No.: US 2023/0057382 A1
(43) Pub. Date: Feb. 23, 2023

(54) SILYL TERMINATED POLYURETHANES AND INTERMEDIATES FOR THE PREPARATION THEREOF

(71) Applicant: Huntsman International LLC, The Woodlands, TX (US)

(72) Inventors: Ya-Mi Chuang, Lanaken (BE); Giulio Martini, Leuven (BE); Christopher Phanopoulos, Moorsel (BE)

(73) Assignee: Huntsman International LLC, The Woodlands, TX (US)

(21) Appl. No.: 17/785,591

(22) PCT Filed: Dec. 17, 2020
(86) PCT No.: PCT/EP2020/086621

§ 371 Date: Jun. 15, 2022

(30) Foreign Application Priority Data
Dec. 23, 2019 (EP) 19219392.8

(51) Int. Cl. C08G 18/83; C08G 18/28; C08G 18/48; C08G 18/22; C08G 18/38; C08G 18/10

(52) U.S. Cl. CPC C08G 18/837; C08G 18/2835; C08G 18/4845; C08G 18/222; C08G 18/289; C08G 18/3893; C08G 18/10; C08G 2150/00; C08G 2170/00; C08G 2190/00

(57) ABSTRACT

The present invention relates to silyl terminated polyurethanes and to intermediates for the preparation thereof. In particular to an allyl-monool-containing initiator, allyl-terminated polyurethane prepolymer and to processes for their preparation. According to another of its aspect, the invention relates to a product obtainable by curing the silyl terminated polyurethane of the invention and to uses thereof.

### CROSS-REFERENCE TO RELATED APPLICATIONS

This application is the National Phase of International Application PCT/EP2020/086621 filed Dec. 17, 2020 which claims priority to European Provisional Application No. 19219392.8 filed Dec. 23, 2019. The noted applications are incorporated herein by reference.

### DESCRIPTION

The present invention relates to silyl terminated polyurethanes and to intermediates for the preparation thereof. In particular to an allyl-monool-containing initiator, to an alkoxylated monool, to an allyl-terminated polyurethane prepolymer and to processes for their preparation. According to another of its aspect, the invention relates to a product obtainable by curing the silyl terminated polyurethane of the invention and to uses thereof.

Commercial compositions containing moisture curable silylated polymers are known and have a number of applications. For example, silyl terminated polyurethanes are useful as coatings, adhesives, sealants, grouts and gaskets and industrial elastomeric goods.

A conventional method for preparing silyl terminated polyurethanes consists in reacting an isocyanate-containing prepolymer with an aminosilane, yielding products having generally a significantly high viscosity, and that are, as a consequence, difficult to further process in the absence of viscosity modifiers. This high viscosity is supposed to be related to hydrogen bonding due to the presence of urea and urethane groups. Current solutions have therefore focused on decreasing or eliminating the urethane or urea content in these silylated polyurethane.

For example, long chain-polyether polyols can be used for preparing the polyurethane, thereby diluting the hydrogen bonding. Increasing the molecular weight of polyether polyol commonly results in extremely high level of undesirable unsaturation in the polymer. The application requires polyether polyols with a high functionality and a low level of unsaturation

Another example, involves the reaction of OH-functional prepolymer with an isocyanatosilane, yielding a urea-free silylated polyurethane. However, isocyanatosilanes may be objectionable from a hazardous material standpoint. Additionally, raw material availability and price are often an issue.

Another example involves the partial or complete allophanatization and/or biuretization of the urethane or urea groups with monoisocyanates, which sterically hinder hydrogen bond formation. This method, however, requires an additional synthetic step after preparation of the silylated polyurethane, which increases production costs. In addition, monoisocyanates have environment, health and safety issues.

US-A1-5227434, proposes a method using polyisocyanate as the coupling agent to bind the molecules of monool together, which provides a clean coupling reaction by avoiding undesirable oligomerization reaction. Even though no NCO-terminated intermediate is produced in this method, it has been found that the allyl terminated prepolymers of US-A1-5227434 undergo undesirable isomerization and/or R-elimination, when adding the silane moiety to the allyl terminated prepolymer. Furthermore, this disclosure uses certain types of hydric initiators, which must be alkoxylated at least 2 times (with propylene oxide), which is highly disadvantageous.

Therefore, there remains a need for silyl terminated polyurethanes and manufacturing processes thereof, which overcome one or more of the afore-mentioned issues.

According to the invention, it is proposed to prepare silyl terminated polyurethanes in a three reaction steps:

a) one-step alkoxylation of an allyl-monool-containing initiator to obtain an allyl monool;
b) direct reaction of allyl monool obtained in step a) with a diisocyanate to obtain an allyl terminated polyurethane; and
c) hydrosilylation of the allyl terminated polyurethane obtained in step b).

It should be noted that step (a) is about the alkoxylation of an allyl-monool-containing initiator, which has not been alkoxylated (e.g. propoxylated) earlier.

The initiator according to the present invention should be understood as being a compound ready to be alkoxylated for the first time, before applying step (b) recited above.

Furthermore, step (b) recited above can be carried out at a temperature below 100° C., preferably below 90° C., more preferably below 85° C., which is particularly advantageous in view of the prior art.

According to the invention, the allyl-monool-containing initiator used in step a) has the general formula I:

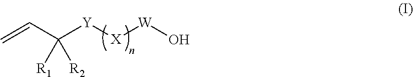

wherein
R₁ is selected from the group consisting of C₁₋₂₄ alkyl, hetero C₁₋₂₄ alkyl, C₃₋₂₄ cycloalkyl, C₆₋₂₄ aryl, C₆₋₂₄ heteroaryl and a group of formula II

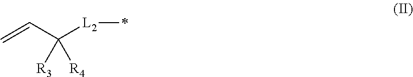

wherein * represents where L₂ is bound to the compound of formula I; and wherein said C₁₋₂₄ alkyl, hetero C₁₋₂₄ alkyl, C₃₋₂₄ cycloalkyl, C₆₋₂₄ aryl, or C₆₋₂₄ heteroaryl can be unsubstituted or substituted with one or more Z₁; and wherein
L₂ is selected from the group consisting of C₁₋₆ alkylene, a single bond, C₃₋₈ cycloalkylene and an oxygen or sulfur atom; and wherein said C₁₋₆ alkylene, or C₃₋₈ cycloalkylene can be unsubstituted or substituted with one or more Z₂;
R₃ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₃;
R₄ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₄; or
R₃ and R₄ together with the carbon atom to which they are attached form a saturated or unsaturated 3, 4, 5, 6 or 7 membered ring; and
R₂ is selected from the group consisting of C₁₋₂₄ alkyl, hetero C₁₋₂₄ alkyl, C₃₋₂₄ cycloalkyl, C₆₋₂₄ aryl, C₆₋₂₄ heteroaryl and a group of formula III

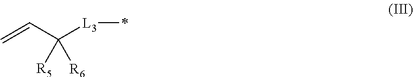

wherein * represents where L₃ is bound to the compound of formula I; and wherein said C₁₋₂₄ alkyl, hetero C₁₋₂₄ alkyl, C₃₋₂₄ cycloalkyl, C₆₋₂₄ aryl, or C₆₋₂₄ heteroaryl can be unsubstituted or substituted with one or more Z₅; and wherein,
L₃ is selected from the group consisting of C₁₋₆ alkylene, a single bond, C₃₋₈ cycloalkylene, and an oxygen or sulfur atom; and wherein said C₁₋₆ alkylene, or C₃₋₈ cycloalkylene can be unsubstituted or substituted with one or more Z₆;
R₅ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₇;
R₆ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₈; or
R₅ and R₆ together with the carbon atom to which they are attached form a saturated or unsaturated 3, 4, 5, 6 or 7 membered ring; and
Y is selected from the group consisting of C₁₋₂₄ alkylene, preferably —CH₂, hetero C₁₋₂₄ alkylene, C₃₋₂₄ cycloalkylene, C₆₋₂₄ arylene, and oxygen or sulfur atom;
   and
wherein,
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, can be unsubstituted or substituted with one or more Z₉ with n equal to 1;
n is an integer from 1 to 24, preferably from 1 to 18, more preferably from 1 to 12 and the most preferably from 1 to 6; and
W and the terminal OH group form together a primary or a secondary alcohol
each of Z₁ to Z₉ is independently selected from the group consisting of C₁₋₆alkoxy, halo C₁₋₆alkoxy, halo, C₁₋₆ alkyl, halo C₁₋₆ alkyl, C₃₋₁₂ cycloalkyl, C₆₋₁₂ aryl, C₆₋₁₂ aryl C₁₋₆ alkyl, C₃₋₁₂ heterocyclyl, and C₄₋₁₂ heteroaryl.

In the frame of the description of the present invention:
C₁₋₂₄ hydrocarbon chain means a saturated or unsaturated hydrocarbon straight or branched chain, with 1 to 24 carbon atoms;
C₁₋₂₄ alkyl as a group or part of a group, refers to a hydrocarbyl radical of formula CnH2n+1 wherein n is a number ranging from 1 to 24. Preferably, the alkyl group comprises from 1 to 20 carbon atoms, for example 1 to 10 carbon atoms, for example 1 to 6 carbon atoms, for example 1 to 4 carbon atoms. Alkyl groups may be linear or branched and may be substituted as indicated herein. When a subscript is used herein following a carbon atom, the subscript refers to the number of carbon atoms that the named group may contain. Thus, for example, C₁₋₂₄ alkyl means an alkyl of 1 to 24 carbon atoms. Thus, for example, C₁₋₆ alkyl means an alkyl of 1 to 6 carbon atoms. Examples of alkyl groups are methyl, ethyl, propyl, isopropyl (i-propyl), butyl, isobutyl (i-butyl), sec-butyl, tert-butyl, pentyl and its chain isomers, hexyl and its chain isomers;
when the suffix “ene” is used in conjunction with an alkyl group, i.e. “alkylene”, this is intended to mean the alkyl group as defined herein having two single bonds as points of attachment to other groups, instead of one single bond. For example, the term “C₁₋₂₀ alkylene”, as a group or part of a group, refers to C₁₋₂₀ alkyl groups that are divalent, i.e., with two single bonds for attachment to two other groups. In a similar manner, the term “C₁₋₆ alkylene”, by itself or as part of another substituent, refers to C₁₋₆ alkyl groups that are divalent, i.e., with two single bonds for attachment to two other groups. Alkylene groups may be linear or branched and may be substituted as indicated herein. Non-limiting examples of alkylene groups include methylene (—CH₂—), ethylene (—CH₂—CH₂—), methylmethylene (—CH(CH₃)—), 1-methyl-ethylene (—CH(CH₃)—CH₂—), n-propylene (—CH₂—CH₂—CH₂—), 2-methylpropylene (—CH₂—CH(CH₃)—CH₂—), ₃-methylpropylene (—CH₂—CH₂—CH(CH₃)—), n-butylene (—CH₂—CH₂—CH₂—CH₂—), 2-methylbutylene (—CH₂—CH(CH₃)—CH₂—CH₂—), 4-methylbutylene (—CH₂—CH₂—CH₂—CH(CH₃)—), pentylene and its chain isomers, hexylene and its chain isomers;
C₃₋₂₄ cycloalkyl as a group or part of a group, refers to a cyclic alkyl group, that is to say, a monovalent, saturated, or unsaturated hydrocarbyl group having 1 or 2 cyclic structure. Cycloalkyl includes all saturated hydrocarbon groups containing 1 to 2 rings, including monocyclic or bicyclic groups. Cycloalkyl groups may comprise 3 or more carbon atoms in the ring and generally, according to this invention comprise from 3 to 24, preferably 3 to 10; more preferably 3 to 6 carbon atoms. Examples of “C₃₋₁₀ cycloalkyl” groups include but are not limited to cyclopropyl, cyclobutyl, cyclopentyl, cyclohexyl, cycloheptyl, cyclooctyl, cyclononyl, cyclodecyl. Examples of “C₃₋₆ cycloalkyl” groups include but are not limited to cyclopropyl, cyclobutyl, cyclopentyl, cyclohexyl;
When the suffix “ene” is used in conjunction with a cycloalkyl group, i.e. cycloalkylene, this is intended to mean the cycloalkyl group as defined herein having two single bonds as points of attachment to other groups, instead of one single bond. Non-limiting examples of “C₃₋₈ cycloalkylene” include 1,2-cyclopropylene, 1,1-cyclopropylene, 1,1-cyclobutylene, 1,2-cyclobutylene, 1,3-cyclopentylene, 1,1-cyclopentylene, and 1,4-cyclohexylene;
C₆₋₁₀ aryl means a hydrocarbon straight or branched chain, with 6 to 10 carbon atoms, at least 6 carbon atoms forming one or more aromatic cycle;
C₆₋₂₄ aryl means a hydrocarbon straight or branched chain, with 6 to 24 carbon atoms, at least 6 carbon atoms forming one or more aromatic cycle;
Where an alkylene or cycloalkylene group is present, connectivity to the molecular structure of which it forms part may be through a common carbon atom or different carbon atom. To illustrate this applying the asterisk nomenclature of this invention, a C₃ alkylene group may be for example *—CH₂CH₂CH₂—*, *—CH(—CH₂CH₃)—* or *—CH₂CH(—CH₃)—*. Likewise, a C₃ cycloalkylene group may be:
The term “heteroalkyl as a

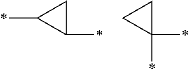

group or part of a group, refers to an acyclic alkyl wherein one or more carbon atoms are replaced by an oxygen, nitrogen or sulphur atom, with the proviso that said chain may not contain two adjacent O atoms or two adjacent S atoms. This means that one or more —CH₃ of said acyclic alkyl can be replaced by —NR₂ and/or that one or more —CH₂— of said acyclic alkyl can be replaced by —NR—, —O— or —S-wherein R is alkyl. The S atoms in said chains may be optionally oxidized with one or two oxygen atoms, to afford sulfoxides and sulfones, respectively. Exemplary heteroalkyl groups include, but are not limited to, alkyl ethers, ketones, alkyl sulfides, and alkyl sulfones;
When the suffix “ene” is used in conjunction with a heteroalkyl group; i.e. “heteroalkylene”, this is intended to mean the heteroalkyl group as defined herein having two single bonds as points of attachment to other groups, instead of one single bond;
The term “haloC₁₋₆ alkyl” as a group or part of a group, refers to a C₁₋₆ alkyl group having the meaning as defined above wherein one, two, or three hydrogen atoms are each replaced with a halogen as defined herein. Non-limiting examples of such haloC₁₋₆ alkyl groups include chloromethyl, 1-bromoethyl, fluoromethyl, difluoromethyl, trifluoromethyl, 1,1,1-trifluoroethyl and the like. It is to be noted that these halogen compounds are less preferred;
The term “C₁₋₆alkoxy” or “C₁₋₆alkyloxy”, as a group or part of a group, refers to a group having the formula —OR_{b} wherein Rb is C₁₋₆ alkyl as defined herein above. Non-limiting examples of suitable C₁₋₆alkoxy include methoxy, ethoxy, propoxy, isopropoxy, butoxy, isobutoxy, sec-butoxy, tert-butoxy, pentyloxy and hexyloxy;
The term “haloC₁₋₆alkoxy”, as a group or part of a group, refers to a group of formula —O—R_{c}, wherein R_{c} is haloC₁₋₆ alkyl as defined herein. Non-limiting examples of suitable haloC₁₋₆alkoxy include fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy, 2,2,2-trichloroethoxy, trichloromethoxy, 2-bromoethoxy, pentafluoroethyl, 3,3,3-trichloropropoxy, 4,4,4-trichlorobutoxy. It is to be noted that these halogen compounds are less preferred;
The term “aryl”, as a group or part of a group, refers to a polyunsaturated, aromatic hydrocarbyl group having a single ring (i.e. phenyl) or multiple aromatic rings fused together (e.g. naphthyl) or linked covalently, typically containing 6 to 24 carbon atoms; preferably 6 to 10 carbon atoms, wherein at least one ring is aromatic. The aromatic ring may optionally include one to two additional rings fused thereto. Aryl is also intended to include the partially hydrogenated derivatives of the carbocyclic systems enumerated herein. Non-limiting examples of aryl comprise phenyl, biphenylyl, biphenylenyl, 5- or 6-tetralinyl, 1-, 2-, 3-, 4-, 5-, 6-, 7- or 8-azulenyl, naphthalen-1- or -2-yl, 4-, 5-, 6 or 7-indenyl, 1-2-, 3-, 4- or 5-acenaphtylenyl, 3-, 4- or 5-acenaphtenyl, 1-, 2-, 3-, 4- or 10-phenanthryl, 1- or 2-pentalenyl, 4- or 5-indanyl, 5-, 6-, 7- or 8-tetrahydronaphthyl, 1,2,3,4-tetrahydronaphthyl, 1,4-dihydronaphthyl, 1-, 2-, 3-, 4- or 5-pyrenyl. “C₆₋₁₀ aryl” refers to an aryl containing 6 to 10 atoms; wherein at least one ring is aromatic. Examples of C₆₋₁₀ aryl include phenyl, naphthyl, indanyl, or 1,2,3,4-tetrahydro-naphthyl;
When the suffix “ene” is used in conjunction with an aryl group; i.e. arylene, this is intended to mean the aryl group as defined herein having two single bonds as points of attachment to other groups, instead of one single bond. For example, the term “C₆₋₂₀ arylene” as a group or part of a group, refers to C₆₋₂₀ aryl groups that are divalent, i.e., with two single bonds for attachment to two other groups; suitable C₆₋₂₀ arylene groups include 1,4-phenylene, 1,2-phenylene, 1,3-phenylene, biphenylylene, naphthylene, indenylene, 1-, 2-, 5- or 6-tetralinylene, and the like;
The term “C₆₋₁₂ arylC₁₋₆ alkyl”, as a group or part of a group, means a C₁₋₆ alkyl as defined herein, wherein at least one hydrogen atom is replaced by at least one C₆₋₁₂ aryl as defined herein. Non-limiting examples of C₆₋₁₂ arylC₁₋₆ alkyl group include benzyl, phenethyl, dibenzylmethyl, methylphenylmethyl, 3-(2-naphthyl)-butyl, and the like;
The terms “heterocyclyl” or “heterocycloakyl” or “heterocyclo”, as a group or part of a group, refer to non-aromatic, fully saturated or partially unsaturated cyclic groups (for example, 3 to 7 member monocyclic, 7 to 11 member bicyclic, or comprising a total of 3 to 10 ring atoms) which have at least one heteroatom in at least one carbon atom-containing ring; wherein said ring may be fused to an aryl, cycloalkyl, heteroaryl or heterocyclyl ring. Each ring of the heterocyclyl group containing a heteroatom may have 1, 2, 3 or 4 heteroatoms selected from N, O and/or S, where the N and S heteroatoms may optionally be oxidized and the N heteroatoms may optionally be quaternized; and wherein at least one carbon atom of heterocyclyl can be oxidized to form at least one C═O. The heterocyclic group may be attached at any heteroatom or carbon atom of the ring or ring system, where valence allows. The rings of multi-ring heterocycles may be fused, bridged and/or joined through one or more spiro atoms;
As used herein, the term “spiro atom” refers to the atom that connects two cyclic structures in a spiro compound. Non limiting examples of spiro atoms include quaternary carbon atoms. As used herein, the term “spiro compound” refers to a bicyclic compound wherein the two rings are connected through one atom;
When the suffix “ene” is used in conjunction with a heterocyclyl group; i.e. “heterocyclylene”, this is intended to mean the heterocyclyl group as defined herein having two single bonds as points of attachment to other groups, instead of one single bond;
The term “heteroaryl” as a group or part of a group, refers but is not limited to 5 to 12 carbon-atom aromatic rings or ring systems containing 1 to 2 rings which are fused together or linked covalently, typically containing 5 to 6 atoms; at least one of which is aromatic in which one or more carbon atoms in one or more of these rings can be replaced by N, O and/or S atoms where the N and S heteroatoms may optionally be oxidized and the N heteroatoms may optionally be quaternized. Such rings may be fused to an aryl, cycloalkyl, heteroaryl or heterocyclyl ring. Non-limiting examples of such heteroaryl, include: pyrrolyl, furanyl, thiophenyl, pyrazolyl, imidazolyl, oxazolyl, isoxazolyl, thiazolyl, isothiazolyl, triazolyl, oxadiazolyl, thiadiazolyl, tetrazolyl, oxatriazolyl, thiatriazolyl, pyridinyl, pyrimidyl, pyrazinyl, pyridazinyl, oxazinyl, dioxinyl, thiazinyl, triazinyl, imidazo[2,1-b][1,3]thiazolyl, thieno[3,2-b]furanyl, thieno[3,2-b]thiophenyl, thieno[2,3-d][1,3]thiazolyl, thieno[2,3-d]imidazolyl, tetrazolo[1,5-a]pyridinyl, indolyl, indolizinyl, isoindolyl, benzofuranyl, isobenzofuranyl, benzothiophenyl, isobenzothiophenyl, indazolyl, benzimidazolyl, 1,3-benzoxazolyl, 1,2-benzisoxazolyl, 2,1-benzisoxazolyl, 1,3-benzothiazolyl, 1,2-benzoisothiazolyl, 2,1-benzoisothiazolyl, benzotriazolyl, 1,2,3-benzoxadiazolyl, 2,1,3-benzoxadiazolyl, 1,2,3-benzothiadiazolyl, 2,1,3-benzothiadiazolyl, benzo[d]oxazol-2(3H)-one; 2,3-dihydro-benzofuranyl; thienopyridinyl, purinyl, imidazo[1,2-a]pyridinyl, 6-oxo-pyridazin-1(6H)-yl, 2-oxopyridin-1(2H)-yl, 6-oxo-pyridazin-1(6H)-yl, 2-oxopyridin-1(2H)-yl, 1,3-benzodioxolyl, quinolinyl, isoquinolinyl, cinnolinyl, quinazolinyl, quinoxalinyl; preferably said heteroaryl group is selected from the group consisting of pyridyl, 1,3-benzodioxolyl, benzo[d]oxazol-2(3H)-one; 2,3-dihydro-benzofuranyl; pyrazinyl, pyrazolyl, pyrrolyl, imidazolyl, benzimidazolyl, pyrimidinyl, triazolyl and thiazolyl;
When the suffix “ene” is used in conjunction with a heteroaryl group; i.e. “heteroarylene”, this is intended to mean the heteroaryl group as defined herein having two single bonds as points of attachment to other groups, instead of one single bond.

Whenever the term “substituted” is used in the present invention, it is meant to indicate that one or more hydrogens on the atom indicated in the expression using “substituted” is replaced with a selection from the indicated group, provided that the indicated atom's normal valency or range of valencies (including charged forms) is not exceeded. Whenever the term “substituted” is used in the present invention, it is meant to indicate that one or more hydrogens on the atom indicated in the expression using “substituted” is replaced with a selection from the indicated group, provided that the indicated atom's normal valency or range of valencies (including charged forms) is not exceeded. Most preferably the substituent should not introduce an unsaturation nor a functional group reactive towards the isocyanate (like an alcohol or an amine).

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The use of these allyl-monool-containing initiators allows to solve the above-mentioned problems. Surprisingly, the present inventors have found that when an allyl-containing prepolymer comprising an allyl terminal group, as presently disclosed, is used in the preparation of polyurethanes, the yield of the subsequent reaction can be substantially improved and undesirable side reactions are avoided. According to the invention, when making said polyurethanes, the use of an allyl-containing prepolymer comprising an allyl terminal group as presently disclosed, significantly lowers percentage of urea groups in the molecule, reducing the amount of hydrogen bonding within the molecules, leading to a silylated polyurethane with much lower viscosity. The low viscosity silylated polyurethanes of the present invention are very advantageous, as they are much easier to process and handle. Furthermore, low viscosity silylated polyurethanes are easier to handle, leading to formulations that are optionally plasticizer-free. Additionally, the process according to the invention makes use of cheaper starting materials, such as hydrosilanes, which reduces the overall cost of production of the present silylated polyurethanes.

The independent and dependent claims set out particular and preferred features of the invention. Features from the dependent claims may be combined with features of the independent or other dependent claims as appropriate. The above and other characteristics, features and advantages of the present invention will become apparent from the following detailed description, which illustrates, by way of example, the principles of the invention.

Such allyl-monool-containing initiator can be purchased or manufactured according to simple organic chemistry reactions known by the skilled person. For example, 2-methyl-3-buten-2-ol, 2-(vinyloxy)ethan-1-ol and 2-allyloxyethanol can be purchased from Sigma Aldrich.

In a preferred embodiment,
R₁ and R₂ are both C₁₋₃ alkyl, preferably —CH₃,
Y is selected from the group consisting of C₁₋₂₄ alkyl, preferably —CH₂, hetero C₁₋₂₄ alkyl, C₃₋₂₄ cycloalkyl, C₆₋₂₄ aryl, O and S;
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁-6 alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene or heteroarylene, can be unsubstituted or substituted with one or more Z₉, with n equal to 1; and
W and the terminal OH group form together an alcohol, preferably a primary or a secondary alcohol.

Those allyl-monool-containing initiators are preferred because they increase the reactivity and/or selectivity of the subsequent reactions.

In a more preferred embodiment,
R₁ and R₂ are both C₁₋₃ alkyl, preferably —CH₃,
Y is —CH₂;
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, or heteroarylene, can be unsubstituted or substituted with one or more Z₉, with n equal to 1; and
W and the terminal OH group form together a primary or a secondary alcohol, preferably W and said terminal OH group are —CH₂—OH or —CH—OH—CH₃.

Those allyl-monool-containing initiators are more preferred because they increase even more the reactivity of the allyl group in the subsequent reaction of hydrosilylation.

In another advantageous embodiment,
R₁ and R₂ are both C₁₋₃ alkyl, preferably —CH₃, when Y is O or S;
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, or heteroarylene, can be unsubstituted or substituted with one or more Z₉, with n equal to 1; and
R₃ and the terminal OH group form together a primary or a secondary alcohol.

Those allyl-monool-containing initiators are the most preferred because they increase the most the reactivity of the allyl group in the subsequent reaction of hydrosilylation.

Advantageously, the monool-containing initiator is aliphatic. It has indeed been observed that aromatic groups can deactivate the allyl group and it is also suspected that such aromatic groups will increase the rigidity of the final product, which is undesirable for elastomeric products.

According to another aspect of the invention, the above defined allyl monool-containing initiator is alkoxylated to provide the allyl monool of the general formula V.

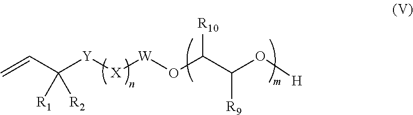

wherein R₉ and R₁₀ are, independently from each other, H or a linear or branched C₁₋₄ alkyl.

The above defined allyl-monool-containing initiator of formula I is thus reacted with at least one alkylene oxide having from 2 to 6 carbon atoms. Suitable alkylene oxide are propylene oxide, ethylene oxide and mixtures thereof.

The allyl monool of the general formula V generally have a molecular weight of 500 to 25000 Dalton, preferably of 800 to 15000 Dalton, more preferably of 800 to 6000 Dalton and most preferably of 1000 to 4000 Dalton.

In an advantageous embodiment, the alkoxylation reaction is performed in the presence of a catalyst selected from the list consisting of basic catalysts, such as KOH, CsOH, potassium methoxide, and double metal cyanide catalysts, such as cobalt, chlorocyano-1,2-dimethoxyethane Zinc complexes.

Preferably the catalyst is removed before the subsequent reaction. Advantageously, said catalyst remains in the solution in an amount of at most 0.500% by weight, preferably at most 0.250% by weight, more preferably at most 0.050% by weight, even more preferably at most 0.001% by weight, based on the total weight of the reaction mixture.

The presence of the catalyst in the subsequent reaction with the isocyanate compound can indeed cause undesirable side reactions.

In some preferred embodiments, the allyl monool of the general formula V can have no covalent hydrogen in gamma position of the allyl moiety. Suitable allyl-terminated polyethers are polyalkylene glycol derivatives wherein one of the terminal hydroxyl groups of the polyalkylene glycol has been exchanged by an allyl group. The polyalkylene glycol may be a homopolymer of alkylene oxide, or a copolymer, resulting from the copolymerization of a mixture of two or more different alkylene oxides.

In some embodiments, the reaction product (allyl monool of the general formula V) according to the present invention can be reacted with the isocyanate-containing compound, along with extender glycol. The extender glycol can be added as part of the chain, but not at all terminal positions of the prepolymer. Non-limiting examples of suitable extender glycols (i.e., chain extenders) include lower aliphatic or short chain glycols having from about 2 to about 10 carbon atoms and include, for instance, ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol, hydroquinone di(hydroxyethyl)ether, neopentylglycol, and the like.

In some embodiments, the reaction product (allyl monool of the general formula V) of the present invention has an average reactive functionality of at least about 1 for each of the alcohol and allyl ends thereof. As used herein, the term “average reactive functionality” refers to the average number of reactive groups (functionality) per molecule, averaged over a statistically relevant number of molecules present in the reaction product (allyl-terminated polymer).

In a further step, the product obtained from the above described alkoxylation reaction is further reacted with an isocyanate-containing compound with the formation of an allyl terminated polyurethane prepolymer. Preferably, this step is carried out at a temperature below 100° C., preferably below 90° C., more preferably below 85° C.

Suitable isocyanate-containing compound according to the present invention may be aromatic, cycloaliphatic, heterocyclic, araliphatic or aliphatic organic isocyanates. Suitable isocyanates include also polyisocyanates. Suitable polyisocyanates for use in preparing the allyl-terminated prepolymers of the invention comprise polyisocyanates of the type Rₐ—(NCO)ᵣ with r being at least 2 and Rₐ being an aromatic or aliphatic group, such as diphenylmethane, toluene, dicyclohexylmethane, hexamethylene, or a similar polyisocyanate and mixtures thereof.

Non-limiting examples of suitable polyisocyanates that can be used in the present invention can be any organic polyisocyanate compound or mixture of organic polyisocyanate compounds, preferably wherein said compounds comprise at least two isocyanate groups.

Non-limiting examples of organic polyisocyanates include diisocyanates, particularly aromatic diisocyanates, and isocyanates of higher functionality. Non-limiting examples of organic polyisocyanates which may be used in the present invention include aliphatic isocyanates such as hexamethylene diisocyanate; and aromatic isocyanates such as diphenylmethane diisocyanate (MDI) in the form of its 2,4′-, 2,2′- and 4,4′-isomers and mixtures thereof (also referred to as pure MDI), the mixtures of diphenylmethane diisocyanates (MDI) and oligomers thereof (known in the art as “crude” or polymeric MDI), m- and p-phenylene diisocyanate, tolylene-2,4- and tolylene-2,6-diisocyanate (also known as toluene diisocyanate, and referred to asTDI, such as 2,4 TDI and 2,6 TDI) in any suitable isomer mixture, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyl-diphenylmethane-4,4′-diisocyanate and diphenyl ether diisocyanate; and cycloaliphatic diisocyanates such as cyclohexane-2,4- and -2,3-diisocyanate, 1-methylcyclohexyl-2,4- and -2,6-diisocyanate and mixtures thereof and bis-(isocyanatocyclohexyl)methane (e.g. 4,4′-diisocyanatodicyclohexylmethane (H12MDI)), triisocyanates such as 2,4,6-triisocyanatotoluene and 2,4,4-triisocyanatodiphenylether, isophorone diisocyanate (IPDI), butylene diisocyanate, trimethylhexamethylene diisocyanate, isocyanatomethyl-1,8-octane diisocyanate, tetramethylxylene diisocyanate (TMXDI), 1,4-cyclohexanediisocyanate (CDI), and tolidine diisocyanate (TODI); any suitable mixture of these polyisocyanates, and any suitable mixture of one or more of these polyisocyanates with MDI in the form of its 2,4′-, 2,2′- and 4,4′-isomers and mixtures thereof (also referred to as pure MDI), the mixtures of diphenylmethane diisocyanates (MDI) and oligomers thereof (known in the art as “crude” or polymeric MDI), and reaction products of polyisocyanates (e.g. polyisocyanates as set out above, and preferably MDI-based polyisocyanates). Preferably diphenylmethane diisocyanate (MDI) or toluene diisocyanates (TDI)-type isocyanates are used.

In some embodiments, the at least one isocyanate may include a carbodiimide and/or uretonimine modified variant of a diisocyanate or higher functionality polyisocyanate as well as isocyanate ended prepolymers made by reaction of an excess of a diisocyanate or higher functionality polyisocyanate with a hydroxyl ended polyester or hydroxyl ended polyether and products obtained by reacting an excess of diisocyanate or higher functionality polyisocyanate with a monomeric polyol or mixture of monomeric polyols such as ethylene glycol, trimethylol propane or butane-diol.

In some embodiments, said at least one isocyanate comprises a polymeric methylene diphenyl diisocyanate.

The polymeric methylene diphenyl diisocyanate can comprise any mixture of pure MDI (2,4′-, 2,2′- and 4,4′-methylene diphenyl diisocyanate) and higher homologues of formula (A):

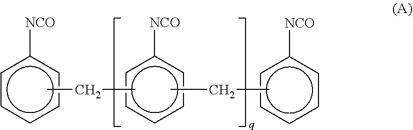

wherein q is an integer which can be from 1 to 10 or higher, preferably does not exclude branched version thereof.

Preferably, the at least one isocyanate is diphenylmethane diisocyanate.

The at least one isocyanate-containing compound for use in the preparation of the allyl-terminated prepolymer of the present invention can have an NCO values ranging from 0.5 wt % to 50 wt % by weight. Preferably from 0.5 wt % to 45 wt %; preferably from 1.0 wt % to 40 wt %; preferably from 1.5 wt % to 35 wt % by weight.

The NCO value (also referred to as percent NCO or NCO content) of the isocyanate-containing compound can be measured by titration with dibutylamine according to standard ASTM D5155 method. The NCO value is expressed in weight %.

In some embodiments, the molar ratio of the NCO of said at least one isocyanate-containing compound, to the OH of said reaction product (allyl-terminated polymer) is ranging from 0.90 to 1.20, preferably from 0.95 to 1.10.

The OH value (also referred to as OH number or OH content) can be measured according to the ASTM D 1957 standard. The OH value is expressed in mg KOH/g.

According to another of its aspects, the invention relates to an allyl terminated polyurethane prepolymer obtainable by the above described process and variants.

Advantageously, the allyl terminated polyurethane prepolymer has a molecular weight comprised between 500 and 15000 Dalton.

In an additional step, the allyl terminated polyurethane prepolymer obtained from the above described process and variants is further reacted with at least one hydrosilane of formula IV to provide a silyl terminated polyurethane:

H—Si—(OR₇)₃₋ₚ(R₈)ₚ (IV)

wherein,
R₇ is selected from C₁₋₂₀ alkyl or C₆₋₂₀ aryl;
R₈ is selected from C₁₋₂₀ alkyl, C₆₋₂₀ aryl, or C₁₋₂₀alkoxy;
p is an integer selected from 0, 1 or 2. When p is o or 1, there are three or two OR₇ groups that must be identical. When p is 2, there are two R₉ groups that do not need to be identical.

Unlike with the prior art where this reaction is generally accompanied by undesirable isomerization or/and β-elimination, the allyl terminated polyurethane prepolymer according to this invention can be hydrosilylated without causing a side reaction, which in turn promotes the cure efficiency in the final product.

Non-limiting examples of hydrosilanes suitable for the present invention include diethoxymethyl silane, triethoxysilane, trimethoxysilane, diethoxyethylsilane, dimethoxymethylsilane, tri(propan-2-yloxy)silane, tributoxy silane, 7-(2-ethoxyethoxy)-3,6,8,11-tetraoxa-7-silatridecane, and mixtures thereof. Preferred hydrosilanes are triethoxysilane, trimethoxysilane, 7-(2-ethoxyethoxy)-3,6,8,11-tetraoxa-7-silatridecane, diethoxyethylsilane, dimethoxymethylsilane, and mixtures thereof.

This step of hydrosilylation can be performed without catalyst or in the presence of at least one catalyst.

Non-limiting examples of suitable catalyst platinum-based catalysts, such as Speier's, Adam's, Ossko's and Karstedt's catalysts; rhodium-based catalysts, such as [Rh(cod)₂]BF₄ and [RhCl(nbd)]₂, and Wilkinson's catalyst (RhCl(PPh₃)₃); ruthenium-based catalysts, such as [Ru(benzene)Cl₂], [Ru(p-cymene)Cl₂], Grubb's 1^{st} generation catalyst and [Cp*Ru(MeCN)₃]PF₆. Adam's catalyst corresponds to platinum oxide (PtO₂), while Ossko's catalyst corresponds to Platinum Carbonyl Cyclovinylmethylsiloxane Complex.

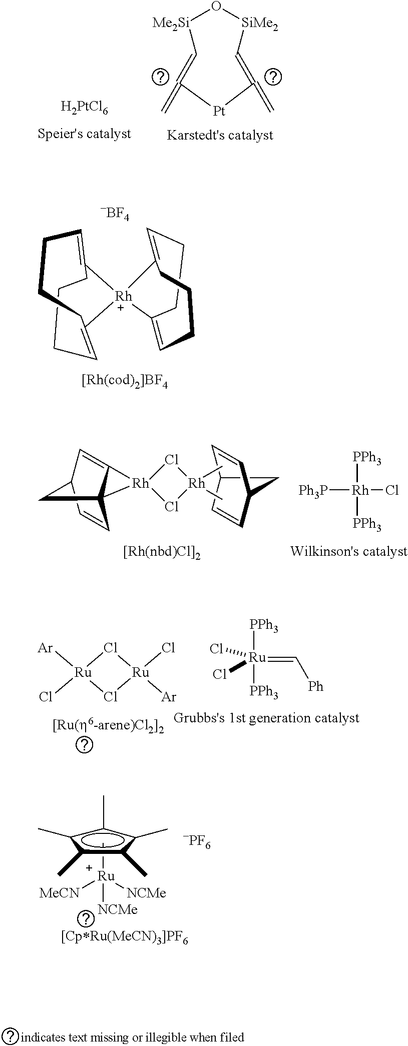

Preferably, the catalyst can be present in an amount of at most 0.0001% by weight, for example at most 0.0009% by weight, for example at most 0.0008% by weight, for example at most 0.0007% by weight, for example at most 0.0006% by weight, for example at most 0.0005% by weight, with % by weight being based on the total weight of the reaction mixture.

According to another of its aspects, the invention relates thus to the silyl terminated polyurethane obtainable by such a process.

Preferably, the silyl-terminated polyurethane comprises at least 0.1% by weight of alkoxyalkylsilane, for example at least 1.0% by weight of alkoxyalkylsilane, for example at least 5.0% by weight of alkoxyalkylsilane, preferably at least 10.0% by weight of hydrosilane, for example at least 15.0% by weight of alkoxyalkylsilane, for example at least 20.0% by weight of alkoxyalkylsilane, for example at least 25.0% by weight of alkoxyalkylsilane, based on the total weight of the polyurethane.

This silyl terminated polyurethane has a much lower viscosity at room temperature than conventional silylated polyurethane and are thereby much easier to use in certain application such as for the preparation of a coating, adhesive or foam. In some preferred embodiments, the viscosity at room temperature of the (non-plasticized) prepolymer ranges from at least 1.0 to at most 50 Pa·s, for example from at least 1.5 to at most 50 Pa·s, for example from at least 1 to at most 25 Pa·s, for example from at least 1 to at most 20 Pa·s, for example from at least 1.5 to at most 25 Pa·s, for example from at least 1.5 to at most 20 Pa·s, measured with a Brookfield Rheometer with a cone and plate geometry using a shear rate of 1 rotation per second and a 100-micron truncation gap.

In another of its aspects, the invention relates to the use of such silyl terminated polyurethane for the preparation of a adhesives, coatings, elastomers, foams, sealants, gaskets and grouts and the like. In some embodiments, the product may be an adhesive. In some embodiments, the product may be an elastomer. In some other embodiments, the product may be a foam such as a one component foam. In yet other embodiments, the product may be a coating. In yet other embodiments, the product may be a sealant.

To this end, the above defined silyl terminated polyurethane is cured (for example with the moisture of the ambient atmosphere or with added water or another curing agent) at a temperature below 70° C., preferably below 60° C., more preferably below 40° C., even more preferably between 0 and 25° C. The invention also relates to the product of this curing.

The silyl-terminated polyurethane may comprise one or more additives. In some embodiments, the additive is present in an amount of at least 0.01% by weight, for example at least 0.03% by weight, for example at least 0.1% by weight, preferably at least 0.3% by weight, for example at least 0.5%, for example at least 1.0% by weight, based on the total weight of the silyl-terminated polyurethane. The additives collectively can be up to 300% by weight based on the total weight of the silyl-terminated polyurethane.

Non-limiting examples of suitable additives include surfactants, fire retardants, chain extenders, cross-linkers, antioxidants, fillers, and mixture thereof.

Examples of surfactants are nonylphenols, fatty acid ethylene oxide condensates and alkylene oxide block co-polymers. The surfactants are used in an amount of 0.1-5% by weight (typically on all isocyanate reactive ingredients). Examples of commercially available surfactants are Tegostab® B 8017 and Ortegol® 501.

Fire retardants include, for example, a phosphorus-based flame retardant, a halogen-based flame retardant, an inorganic flame retardant and expandable graphite. Specific examples of fire retardants include, for example, 2-chloro-1-methylethyl phosphate, tetrabromobisphenol A, tris-chloroethyl phosphates, ammonium phosphate and polyphosphate.

Non-limiting examples of antioxidants are sterically hindered phenols, diphenylamines and benzofuranone derivatives. Examples of commercially available anti-oxidants: Vanox® 945 available from Vanderbilt Chemicals and Irganox® 1135 available from BASF.

Non-limiting examples of fillers are mineral fillers like BaSO₄ and CaCO₃, carbon black, mineral fibers like glass fibers and rock wool fibers, micro-spheres, fumed silica, titanium dioxide, wood chips, wood dust, wood flakes, wooden plates; paper and cardboard (both shredded or layered); sand, vermiculite, clay, cement and other silicates; ground rubber, ground thermoplastics, ground thermoset materials; metal particles and plates; cork in particulate form or in layers; natural fibers, like flax, hemp and sisal fibers; synthetic fibers, like polyamide, polyolefin, polyaramide, polyester and carbon fibers; nanoparticles like clays, inorganic oxides and carbons; glass beads, ground glass, hollow glass beads; expanded or expandable beads; untreated or treated waste like milled, chopped, crushed or ground waste and in particular fly ash; woven and non-woven textiles; and combinations of two or more of these materials. In certain embodiments, such fillers can be coated with functionalized hydrocarbon.

Other suitable additives include plasticizer, smoke-suppressants, catalysts, coloring agents and/or pigments (inorganic and organic, such as carbon black, iron oxide, etc.), antimicrobial agents, mould release agents, hindered amine light stabilizers (HALS), UV absorbers, water scavenger, emulsifiers, thixotropic agents (such as polyamide waxes, aerosols, etc.), adhesion promotors, rheology modifiers, reactive diluents, anti-foaming agents, blowing agents, co-polymers, possibly multiple versions of each type of additive and combinations thereof.

The additive may be a plasticizer. Preferably, the amount of plasticizer in the silyl-terminated polyurethane is limited. Suitable plasticizers, for purposes of the present invention, comprise conventional plasticizers known in the art, such as esters of dibasic or polybasic carboxylic acids with monohydric alcohols. Other examples of suitable plasticizers may be selected from the group comprising phthalates, such as dioctyl phthalate, diisooctyl phthalate, diisononyl phthalate, dimethyl phthalate, dibutyl phthalate; the phthalates with more than eight carbon atoms are preferred; phosphates, such as tributyl phosphate, triethyl phosphate (TEP), triphenyl phosphate and cresyl diphenyl phosphate; chlorinated biphenyls; aromatic oils; adipates, such as diisononyl adipate and di-(2-ethylhexyl) adipate; and combinations thereof. Other examples of suitable plasticizers comprise phosphoric acid esters of the branched and unbranched aliphatic, cycloaliphatic and aromatic alcohols. If appropriate, phosphates of halogenated alcohols can also be employed. So called polymeric plasticizers can also be employed. Examples of such plasticizers may be selected from the group comprising polyesters of adipic acid, sebacic acid or phthalic acid. Phenol alkysulfonates, e.g. phenyl paraffinsulfonates, can also be employed. Plasticizers may also be selected from alkylene carbonates, such as propylene carbonate and ethylene carbonate.

The invention is illustrated but not limited by the following examples.

### Comparative Example 1 (Preparation of the Allyl Monool of Formula V, Wherein R₁ and R₂ Represent H, Y Represents an Oxygen Atom, X and W Represent CH₂, R₉ is CH₃ and n is 1)

0.49 g of DMC catalyst (double metal cyanide-Cobalt, chloro cyano 1,2-dimethoxyethane zinc complexes, sold by Hongkong Huarun International Co. Ltd., RN: 116912-63-1) was added to 312 g of 2-allyloxyethanol (allyl-monool-containing initiator of formula I, wherein R₁ and R₂ represent H, Y represents an oxygen atom, X and W represent CH₂ and n is 1) in a pressure vessel and the temperature was raised to 110° C. A small amount of propylene oxide was added to the reaction vessel. As a result, the pressure in the vessel (1 bar) increased due to the charging of the latter product. After an observed pressure drop (alkoxylation reaction taking place), the remaining required theoretical mass of propylene oxide was added (4460 g in total) in order to target a molecular weight around 2000 g/mol. The mixture was blanketed with nitrogen and the reaction mixture was pressurized with one bar of propylene oxide. Alter the complete addition of propylene oxide, no subsequent pressure drop was observed. Finally, 500 ppm of antioxidant (Irganox® 1076) were added to the product and the material was discharged in a 5 L metal can.

The obtained product has an acid value of 37.4 mg KOH/g, an unsaturation value of 0.667 meq/g and a molecular weight of 1500 Dalton.

### Comparative Example 2 (Preparation of an Allyl Terminated Polyurethane Prepolymer)

The product obtained at example 1 was placed in the reaction vessel, pro-flushed with nitrogen and heated to 80° C. The required stoichiometric amount of 1,1′-methylenebis(4-isocyanatobenzene) (4,4′-MDI sold as SUPRASEC® 1306 by HUNTSMAN) was added via heated addition funnel in order to maintain the material as a liquid. The addition rate was 1.5 mL/min. The reaction mixture was mechanically stirred at 350 rpm and left to react under nitrogen. The isocyanate value was monitored over time and when the value was constant (3 titrations performed every 15 min) the vessel was cooled to room temperature. The product was then discharged in a tin can and characterized.

### Comparative Examples 3.1 to 3.4 (Preparation of a Silyl Terminated Polyurethane)

50 g of the product obtained at comparative example 2 are introduced (without any solvent) in a reaction vessel together with 1.05 equivalents of diethoxymethyl silane (hydrosilane of formula IV wherein R₇ represents an ethoxy, R8 a methoxy and p is 2). The temperature was set to 90° C. DMC catalyst (double metal cyanide-Cobalt, chloro cyano 1,2-dimethoxyethane zinc complexes, sold by Hongkong Huarun International Co. Ltd., RN: 116912-63-1) in several quantities was added to the reaction vessel as well as the hydrosilylation catalyst (Karstedt's catalyst is an organoplatinum compound derived from divinyl-containing disiloxane) in several quantities.

The viscosity was measured via Rheometrics (a Brookield Rheometer (325-1 spindle at 350 Pa) with a cone and plate geometry (CONE SST 20 mm×0.5), using a shear rate of 1 rotation per second, and a 100 micron truncation gap. The viscosity was measured at ambient temperature. TABLE I provides the details of these examples.

TABLE 1

| Comparative | DMC Catalyst | Karstedt's catalyst | Yield | Viscosity |
|---|---|---|---|---|
| Example | (ppm) | (ppm) | (mol %) | (Pa.s) |
| 3.1 | 0 | 10 ppm | 95.0 | 4.8 |
| 3.2 | 100 | 5 ppm | 92.5 | 4.9 |
| 3.3 | 100 | 2.5 ppm | 91.5 | 5.1 |
| 3.4 | 100 | 20 ppm | 90.5 | 5.3 |

As can be seen in TABLE I, all the silyl terminated polyurethane have a viscosity of about 5 Pa·s. This value of the viscosity is to be compared with conventional silylated polyurethane having generally a viscosity of 50 Pa·s or above.

### Comparative Example 4 (Use of the Silyl Terminated Polyurethane)

Lap joints were prepared from beech wood, PVC and Aluminum substrates (Rochell, 4×25×100 mm) loaded with the silyl terminated polyurethane of example 3.4 with a 0.45 g glue load (6.25 cm² overlap area, 0.1 mm thickness). Prior to lap join, PVC and Aluminum was washed with acetone followed by drying or evaporation; and wood was pro-heated and cured in a Weiss cabinet at 23° C. and 50% RH for two days. The lap joints were placed between 2 metal plates and pressed with a constant weight load (2.6 kg). Lap shear strength was determined with an Instron universal testing instrument using a 50 mm/min deformation rate. For that test, spacers were used, identical to the lap joints substrate thickness to ensure parallel application of strain before tangential force is applied.

The tensile shear and elongation at break were measured for all the coatings. The results are provided in TABLE II.

TABLE 11

| Comparative | | Tensile shear | Elongation at break |
|---|---|---|---|
| Example | Substrate | (MPa) | % |
| 4.1 | Beech wood | 0.27 ± 1.3 | 15 ± 5 |
| 4.2 | Aluminum | 0.34 ± 0.7 | 15 ± 5 |
| 4.3 | PVC | 0.44 ± 0.6 | 15 ± 5 |

### Example 1 According to the Invention

0.197 g of DMC catalyst (double metal cyanide-Cobalt, chloro cyano 1,2-dimethoxyethane zinc complexes, sold by Hongkong Huarun International Co. Ltd., RN: 116912-63-1) were added to 75 g of 3,3-dimethyl-4-penten-1-ol (allyl monool-containing initiator of formula 1, wherein R₁ and R₂ represent CH₃, Y and W represent CH₂ and n is 0) in a pressure vessel and the temperature was raised to 120° C. keeping the system under vacuum until 60° C. Propylene oxide is then added to the reaction vessel. As a result, the pressure of the vessel (1 bar) increased due to the charging of the latter product. After an observed pressure drop (alkoxylation reaction taking place), the remaining required theoretical mass of propylene oxide (719 g in total) was added in order to get a molecular weight around 1500 g/mol. The mixture was blanketed with nitrogen and the reaction mixture was pressurized with 1 bar of propylene oxide. After the complete addition of propylene oxide, no subsequent pressure drop was observed.

The obtained product has a hydroxyl value of 37.4 mg KOH/g, an unsaturation content of approximately 0.667 meq/g and a molecular weight of 1500 Dalton.

### Example 2 According to the Invention

The product obtained in example 1 according to the invention was placed in a reaction vessel pre-flushed with nitrogen and heated to 80° C. A stoichiometric amount of 1,1′-methylenebis(4-isocyanatobenzene) (4,4′-MDI, SUPRASEC® 1306 by HUNTSMAN) was added via heated addition funnel to maintain the product liquid. The addition rate was 1.5 ml/min. The reaction mixture was allowed to react without any additional catalyst under mechanical stirring (350 rpm) in nitrogen atmosphere. The isocyanate value was monitored to follow the reaction until constant value (3 titrations performed every 15 minutes), then the vessel was discharged. The product was stored in a metal container under nitrogen and allowed to cool down at room temperature. All the hydroxyl groups were fully reacted with the isocyanate to form an allyl terminated polyurethane prepolymer.

### Example 3 According to the Invention

50 g of the product of example 2 according to the invention were dissolved in 100 ml of toluene and introduced in a reaction vessel. 40 ppm of Karsted's catalyst are added together with 1.95 equivalents of trimethoxysilane. The temperature was increased to 90° C. and the mixture was allowed to react for 3 hours under magnetic stirring. The reaction was followed by 1H NMR until no further changes were observed in the spectrum. Once the reaction was completed, the solvent was stripped and the product isolated as a low-viscosity liquid resin.

As shown in table Ill, when R₁═R₂═CH₃ the known isomerization and elimination side products are not formed because of the presence of substituents on the γ-carbon. Therefore, an accurate choice of propoxylation initiator will lead to higher selectivity towards the desired reaction product.

TABLE III
Comparison of reaction products obtained starting from different initiators.

| | Target product (trimethoxysilane) | Side products |
|---|---|---|
| Initiator | Hydrosilylated material | Isomerized unsaturated end groups |
| 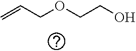 | 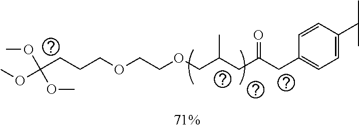 | 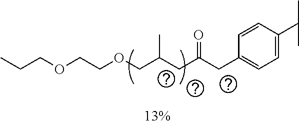 |
| 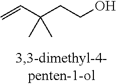 | 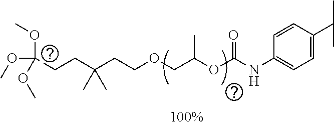 | |
| | | Comparison of reaction products obtained |
| | | starting from different initiators. |
| | | Side products |
| | Initiator | β-elimination silylated end groups |
| | 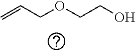 | 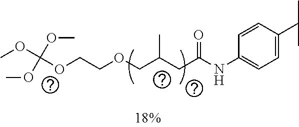 |
| | 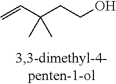 | |

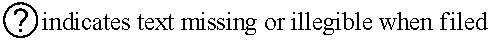

1. An allyl-monool-containing initiator for the preparation of a Silyl terminated polyurethane, which initiator has the general formula 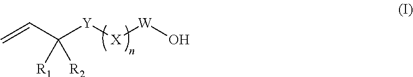
wherein
R₁ is selected from the group consisting of C₁₋₂₄ alkyl, hetero C₁₋₂₄ alkyl, C₃₋₂₄ cycloalkyl, C₆₋₂₄ aryl, C₆₋₂₄ heteroaryl and a group of formula II 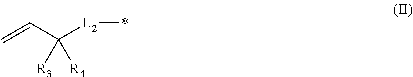
wherein * represents where L₂ is bound to the compound of formula I; and wherein said C₁₋₂₄ alkyl, hetero C₁₋₂₄ alkyl, C₃₋₂₄ cycloalkyl, C₆₋₂₄ aryl, or C₆₋₂₄ heteroaryl can be unsubstituted or substituted with one or more Z₁; and wherein,
L₂ is selected from the group consisting of C₁₋₆ alkylene, a single bond, C₃₋₈ cycloalkylene, O, and S; and wherein said C₁₋₆ alkylene, or C₃₋₈ cycloalkylene can be unsubstituted or substituted with one or more Z₂;
R₃ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₃;
R₄ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₄; or
R₃ and R₄ together with the carbon atom to which they are attached form a saturated or unsaturated 3, 4, 5, 6 or 7 membered ring; and
R₂ is selected from the group consisting of C₁₋₂₄ alkyl, hetero C₁₋₂₄ alkyl, C₃₋₂₄ cycloalkyl, C₆₋₂₄ aryl, C₆₋₂₄ heteroaryl and a group of formula III 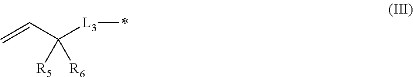
wherein * represents where L₃ is bound to the compound of formula I; and wherein said C₁₋₂₄ alkyl, hetero C₁₋₂₄ alkyl, C₃₋₂₄ cycloalkyl, C₆₋₂₄ aryl, or C₆₋₂₄ heteroaryl can be unsubstituted or substituted with one or more Z₅; and wherein,
L₃ is selected from the group consisting of C₁₋₆ alkylene, a single bond, C₃₋₈ cycloalkylene, O, and S; and wherein said C₁₋₆ alkylene, or C₃₋₈ cycloalkylene can be unsubstituted or substituted with one or more Z₆;
R₅ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₇;
R₆ is selected from the group consisting of C₁₋₆ alkyl, hetero C₁₋₆ alkyl, C₃₋₁₀ cycloalkyl, and C₆₋₁₀ aryl; and wherein said C₁₋₆ alkyl, hetero C₁₋₆ alkyl, C₃₋₁₀ cycloalkyl, and C₆₋₁₀ aryl can be unsubstituted or substituted with one or more Z₈; or
R₅ and R₆ together with the carbon atom to which they are attached form a saturated or unsaturated 3, 4, 5, 6 or 7 membered ring; and
Y is selected from the group consisting of C₁₋₂₄ alkylene, hetero C₁₋₂₄ alkylene, C₃₋₂₄ cycloalkylene, C₆₋₂₄ arylene, and oxygen or sulfur atom;
and
wherein,
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, can be unsubstituted or substituted with one or more Z₉ with n equal to 1;
n is an integer from 1 to 24; and
W and the terminal OH group form together a primary or a secondary alcohol
each of Z₁ to Z₉ is independently selected from the group consisting of C₁₋₆alkoxy, halo C₁₋₆alkoxy, halo, C₁₋₆ alkyl, halo C₁₋₆ alkyl, C₃₋₁₂ cycloalkyl, C₆₋₁₂ aryl, C₆₋₁₂ aryl C₁₋₆ alkyl, C₃₋₁₂ heterocyclyl, and C₄₋₁₂ heteroaryl.

2. The allyl-monool-containing initiator according to claim 1, wherein:
R₁ and R₂ are both C₁₋₃ alkyl,
Y is selected from the group consisting of C₁₋₂₄ alkyl, hetero C₁₋₂₄ alkyl, C₃₋₂₄ cycloalkyl, C₆₋₂₄ aryl, O and S;
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene or heteroarylene, can be unsubstituted or substituted with one or more Z₉, with n equal to 1; and
W and the terminal OH group form together an alcohol.

3. The allyl-monool-containing initiator according to claim 1, wherein:
R₁ and R₂ are both C₁₋₃ alkyl,
Y is —CH₂;
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, or heteroarylene, can be unsubstituted or substituted with one or more Z₉, with n equal to 1; and
W and the terminal OH group form together a primary or a secondary alcohol.

4. The allyl-monool-containing initiator according to claim 1, wherein:
R₁ and R₂ are both C₁₋₃ alkyl, when Y is O or S;
X is selected from the group consisting of C₁₋₂₄ hydrocarbon chain, C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, and heteroarylene, wherein said C₁₋₂₄ alkylene, hetero C₁₋₂₄ alkylene, C₃₋₂₄ cycloalkylene, C₆₋₂₄ arylene, poly C₁₋₆ alkyleneoxide, poly C₆₋₁₀ aryleneoxide, heterocyclylene, or heteroarylene, can be unsubstituted or substituted with one or more Z₉, with n equal to 1; and
R₃ and the terminal OH group form together a primary or a secondary alcohol.

5. The allyl-monool-containing initiator according to claim 1, wherein the initiator is aliphatic.

6. An allyl terminated polyurethane prepolymer obtained by a process comprising the following steps:
(i) reacting the allyl-monool-containing initiator as defined in claim 1 with at least one alkylene oxide having from 2 to 6 carbon atoms; and
(ii) directly reacting the reaction product obtained in step (i) with an isocyanate-containing compound with the formation of an allyl terminated polyurethane prepolymer.

7. The allyl terminated polyurethane prepolymer according to claim 6, wherein step (i) is performed in the presence of a catalyst selected from the list consisting of basic catalysts, and a double metal cyanide catalysts.

8. The allyl terminated polyurethane prepolymer according to claim 7, wherein said catalyst is totally or partly removed before step (ii) and is present in an amount of at most 0.500% by weight based on the total weight of the reaction mixture.

9. The allyl terminated polyurethane prepolymer according to claim 6, wherein said at least one alkylene oxide having from 2 to 6 carbon atoms is selected from propylene oxide, ethylene oxide and mixtures thereof.

10. The allyl terminated polyurethane prepolymer according to claim 6, wherein the allyl terminated prepolymer has a molecular weight comprised between 500 and 15000 Dalton.

11. The allyl terminated polyurethane prepolymer according to claim 6, wherein step (ii) is carried out at a temperature below 100° C.

12. A silyl terminated polyurethane obtained by a process comprising reacting the allyl terminated polyurethane prepolymer according to claim 6 with at least one hydrosilane of formula IV:
H—Si—(OR₇)₃₋ₚ(R₈)ₚ (IV)
wherein,
R₇ is selected from C₁₋₂₀ alkyl; and C₆₋₂₀ aryl;
R₈ is selected from C₁₋₂₀ alkyl; C₆₋₂₀ aryl, C₁₋₂₀alkoxy;
p is an integer selected from 0, 1 or 2,
with the proviso that when p is o or 1, then all the OR₇ groups are identical and
when p is 2, the R₈ groups can be different.

13. The silyl terminated polyurethane according to claim 12, wherein said at least one hydrosilane is selected from the group comprising diethoxymethylsilane, triethoxysilane, trimethoxysilane, diethoxyethylsilane, dimethoxymethylsilane, tri(propan-2-yloxy)silane, tributoxysilane, 7-(2-ethoxyethoxy)-3,6,8,1 1-tetraoxa-7-silatridecane, and mixtures thereof.

14.-15. (canceled)
